(19) United States
(12) Patent Application Publication
(10) Pub. No.: US 2009/0164586 A1
(43) Pub. Date: Jun. 25, 2009

(54) METHOD AND SYSTEM FOR MANAGING THE RECEPTION OF MESSAGES IN A COMMUNICATION NETWORK

(75) Inventors: PAUL B. DOUGLAS, SHARDLOW DERBY (GB); ANDREW I. THOMPSON, SOUTHAMPTON (GB)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/962,374

(22) Filed: Dec. 21, 2007

(51) Int. Cl. G06F 15/16

(52) U.S. Cl. 709/206

(57) ABSTRACT

A method and system for managing the reception of messages in a communication network (100) includes a first client node (102) polling (404) a server node (110) to check for the arrival of a first message that is related to a first message account at the server node (110). The first client node has a pull-message configuration for the first message account. The method also includes receiving (410) a push-message at the first client node. The push-message notifies the first client node of the arrival of a second message at the server node that is related to the first message account. Further, the method includes changing (502) the first client node from a pull-message configuration to a push-message configuration, based on the push-message. Furthermore, the method includes the first client node terminating (506) the polling of the server node for the first message account.

The present invention generally relates to the field of communications, and more particularly, to a method and system for managing the reception of messages in a communication network.

### BACKGROUND

The deployment and use of handheld communication devices to exchange information in a communication network is widespread and likely to continue to grow. Examples of the handheld communication devices include, but are not limited to mobile phones, smart phones, Personal Digital Assistants (PDAs), two-way radios, laptop computers, and pagers. These handheld communication devices can communicate in the communication network through electronic mail (email) systems. Further, emails can be sent and/or received by using various email protocols, such as Post Office Protocol Version 3 (POP3), Simple Mail Transfer Protocol (SMTP), Internet Mail Access Protocol, Version 4 (IMAP4), and Multipurpose Internet Mail Extensions (MIME).

Typically, handheld communication devices can be referred to as email client nodes. The email client nodes interact with an email server node for communication with other email client nodes in the email communication network. Examples of email server nodes include, but are not limited to an email server node with a web interface and an email server with a client interface. The email server node can store emails associated with the email accounts of the email client nodes. Further, each of the email client nodes can receive and retrieve emails associated with its email account from the email server node according to the configuration of the email account.

Many methods exist for receiving and retrieving messages associated with the email accounts from the email server node. Some of these methods are based on “pull” messaging technology. If a message account of an email client node is configured as a pull-message account, the email client node polls the email server node periodically to check for the arrival of a new message associated with the pull-message account of the email client node. When the new message associated with the pull-message account arrives at the email server node, the new message waits at the email server node until the email client node polls the email server node. Then the email client node can retrieve or download the new message.

When using pull messaging technology, if no new messages arrives at the email server node, periodic polling of the email server node depletes a significant amount of energy of the battery of the email client node without producing any benefits. Further, the periodic polling by the email client nodes of the email server node results in an increase of network traffic. Also, polling involves ‘handshaking’ between an email client node and an email server node. The handshaking is a process of establishing the communication rules between the email client node and the email server node, prior to the actual communication. When the email server node is busy, there can be a delay in completing the handshake. As a result, the email client node may have to wait before receiving any new messages. Hence, even if a new message awaits, pull messaging technology for message reception and retrieval may result in delayed retrieval of messages from the email server node.

In contrast to “pull” messaging technology, there exist methods based on “push” messaging technology for receiving and retrieving messages from an email server node. When a message account of an email client node is configured as a push-message account, the email server node has the real-time capability to notify the email client node (or push) a new message associated with the push-message account, as soon as the new message arrives at the email server node. In other words, the email server node pushes the new message to the email client node without waiting to get polled by the email client node.

The push messaging technology requires a dedicated connection between an email client node and an email server node. This means that implementation of the push messaging technology necessitates the use of dedicated and specific hardware configurations for the network and associated communication devices.

### BRIEF DESCRIPTION OF THE FIGURES

The accompanying figures, where like reference numerals refer to identical or functionally similar elements throughout the separate views, and which, together with the detailed description below, are incorporated in and form part of the specification, serve to further illustrate various embodiments, and explain various principles and advantages, all in accordance with the present invention.

FIG. 1 illustrates an exemplary communication network in which various embodiments of the present invention can be practiced;

FIG. 2 is a block diagram illustrating various system elements of a first client node, in accordance with various embodiments of the present invention;

FIG. 3 is a sequence diagram illustrating a method for managing the reception of messages in a communication network, in accordance with an embodiment of the present invention; and

FIGS. 4 and 5 illustrate a flow diagram of a method for managing the reception of messages in a communication network, in accordance with another embodiment of the present invention.

Skilled artisans will appreciate that elements in the figures have been illustrated for simplicity and clarity and have not necessarily been drawn to scale. For example, the dimensions of some of the elements in the figures may be exaggerated, relative to the other elements, to help in improving an understanding of the embodiments of the present invention.

### DETAILED DESCRIPTION

A method and system for managing the reception of messages at a client node in a communication network allows a client node to conveniently switch from a “pull” messaging technology to a more efficient “push” messaging technology. The communication network includes one or more client nodes and a server node, which stores messages associated with the one or more client nodes. The messages can be electronic mail messages (emails) or Instant Messages (IMs). The one or more client nodes can interact with the server node to retrieve the messages. Each client node of the one or more client nodes has one or more message accounts associated with it. A message account can be an email message account or an instant message account. The one or more message accounts can either have a pull-message configuration or a push-message configuration. If the server node changes such that it goes from a pull-message configuration to a push-message configuration, the disclosed method and system switches the client node from a pull-message configuration to a push-message configuration.

A first client node of the one or more client nodes has at least a first message account associated with it, and the first message account is configured as a pull-message configuration. Therefore, the first message account has to poll the server node to check for the arrival of one or more new messages (such as emails) at the server node associated with the first message account. When there are new emails at the server node, the polling results show the arrival of new emails, and the first client node can retrieve and read the new emails. Subsequently, the server node may be changed to handle a push-message configuration. After receiving a push-message associated with the first message account from the reconfigured server node, the first client node changes the configuration of the first message account to a push-message configuration. The push-message from the server node notifies the first client node about the arrival of a new message at the server node associated with the first message account. When the configuration of the first message account at the first client node is changed from a pull-message configuration to a push-message configuration, the first client node stops polling the server node. Thereafter, the first client node having the push-message configuration for the first message account receives a push-message from the server node whenever a new message associated with the first message account arrives at the server node. Thus, client nodes do not need to be recalled and reprogrammed if a pull server node is reprogrammed or replaced to be a push server node.

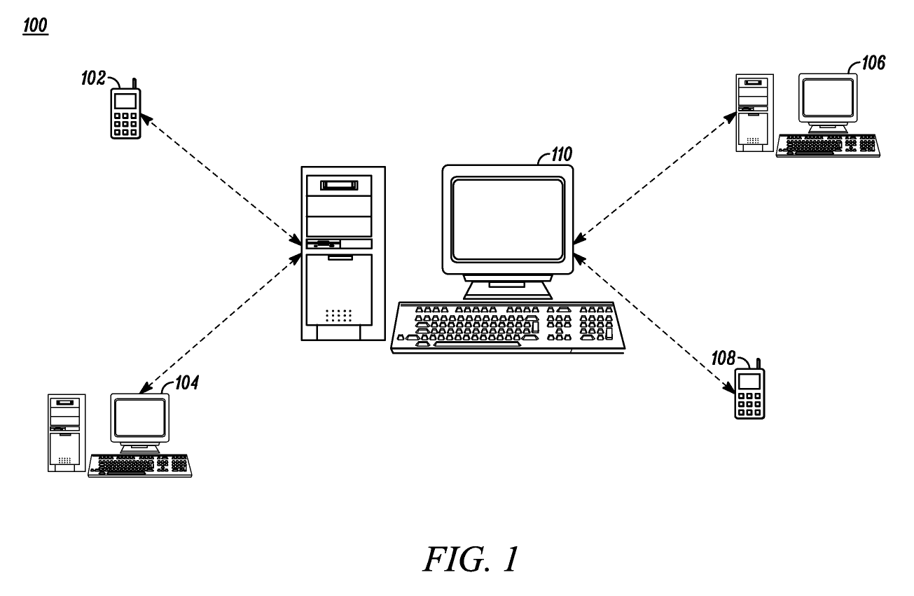

FIG. 1 illustrates an exemplary communication network 100, where various embodiments of the present invention can be practiced. Examples of the communication network 100 include, but are not limited to, a Local Area Network (LAN), a Wireless LAN, a Wide Area Network (WAN), a wireless WAN (such as a cellular system), and a Public Switched Telephone Network (PSTN). Further, the communication network 100 includes one or more client nodes such as a first client node 102, a second client node 104, a third client node 106, and a fourth client node 108. The client nodes 102, 104, 106 and 108 are hereinafter collectively referred to as client nodes. For one embodiment, these client nodes can be devices that enable users to communicate with each other in the communication network 100 via emails or Instant Messages (IM). All these client nodes are depicted as wireless devices. Examples of such client nodes include, but are not limited to, mobile phones, smart phones, Personal Digital Assistants (PDAs), two-way radios, laptop computers, and pagers. The communication network 100 also includes a server node 110. Examples of the server node 110 include, but are not limited to, an email server, a web server, an Internet server, a Yahoo™ server, and a proxy server. When the client nodes communicate via email, the client nodes can be referred as email client nodes and the server node 110 can be a network of individual email servers. The server node 110 enables the exchange of data between communicating email client nodes. For example, the server node 110 can receive an email message from the second client node 104 addressed to an email account for the first client node 102 and store the email message locally. Further, the first client node 102 can retrieve the email message from the server node 110. It will be apparent to a person ordinarily skilled in the art that the communication network 100 can include more or fewer email client nodes and server nodes than described in FIG. 1, in various implementations of the invention.

For one embodiment, each client node has one or more message accounts associated with it to facilitate communication with other email client nodes. The message accounts can be electronic mail (email) accounts or IM accounts. Examples of various message accounts include, but are not limited to, Google™ mail accounts, Yahoo™ mail accounts, Microsoft Outlook, and Hotmail™ accounts. Further, a message account can be identified by a message account Identifier (ID) such as jim_taurus@gmail.com, raven1234@yahoo.com modi_paritosh@yahoo.co.in, etc. Although, the present invention is applicable to both email accounts and IM accounts, for the sake of clarity in description the embodiments have been described with reference to email accounts.

The server node 110 can store messages associated with one or more email accounts of the email client nodes. For example, the server node 110, e.g. a Yahoo™ server, can store email message(s) for the Yahoo™ mail accounts of the email client nodes. It will be apparent to a person ordinarily skilled in the art that although the server node 110 stores messages for each of the email client nodes, and each of the email client nodes can retrieve email messages from the server node 110, for the sake of clarity in description the invention has been described with reference to the first client node 102 and the server node 110.

The first client node 102 communicates with the server node 110 and other email client nodes via the communication network 100. The communication between the email client nodes and the server node can be enabled by a communication network service provider, e.g., an Internet Service Provider (ISP), a network service provider, a network operator, and/or a proprietary network email service provider. The user of the first client node can use a communication network service provider, for example, the proprietary network email service provider, to create one or more email accounts. Further, the first client node 102 has message software installed on it. The message software, such as an email client, is a front-end software program that is used to manage the email messages of the message accounts of the first client node 102. Examples of the message software include, but are not limited to, open-source Mozilla Thunderbird™, Microsoft Outlook™, a Mail User Agent (MUA), and Mutt™. The message software enables a user of the first client node 102 to compose, receive, send, and/or read email messages by using various email message accounts. Further, the email client supports various email protocols such as Post Office Protocol Version 3 (POP3), Simple Mail Transfer Protocol (SMTP), Internet Mail Access Protocol, Version 4 (IMAP4), Multipurpose Internet Mail Extensions (MIME), etc.

The first client node 102 can have one or more email accounts associated with it, such as a first message account, a second message account, and a third message account, hereinafter collectively referred to as email accounts. For one embodiment, the email accounts of the first client node 102 are associated with a single user of the first client node 102. For another embodiment, the email accounts are associated with one or more users of the first client node 102. Further, the first client node 102 can have different configurations for the email accounts of the first client node 102. For example, the first client node 102 can have a pull-message configuration for the first message account and a push-message configuration for the second message account.

When the first message account of the first client node 102 is configured as the pull-message configuration, the first client node 102 polls the server node 110 periodically for the arrival of any new message associated with the first message account. The new message can be an email message received from, for example, the second client node 104.

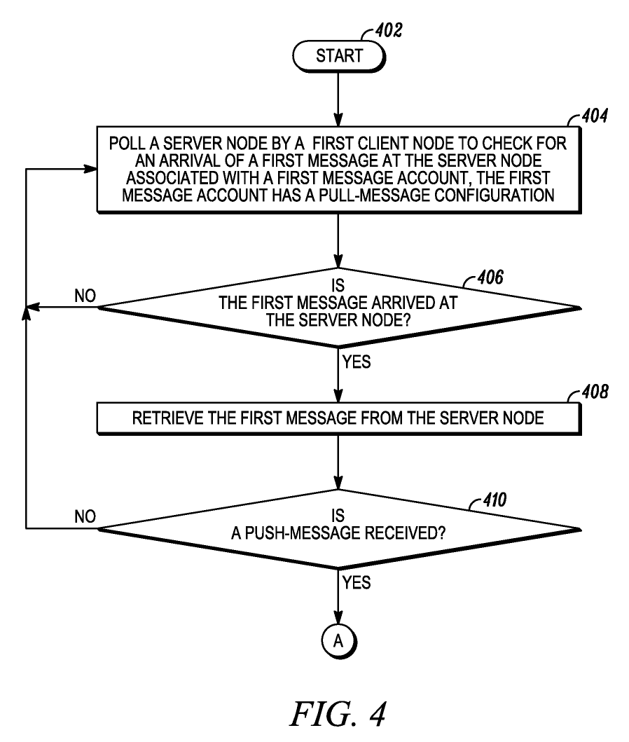

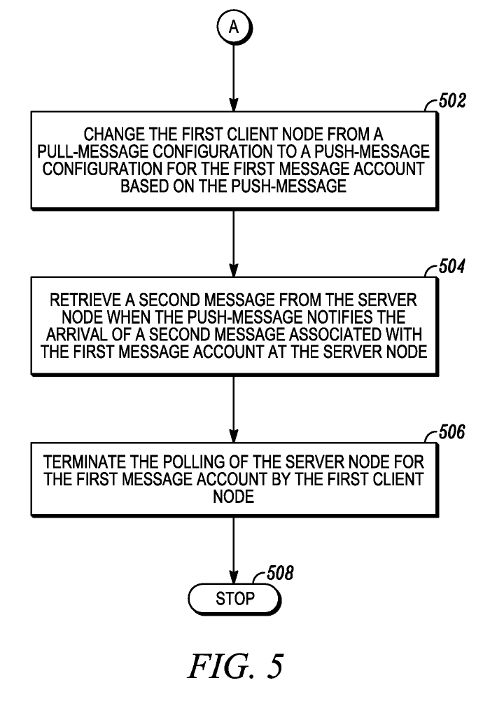

Various embodiments of the present invention enable the first client node 102 to change from a pull-message configuration to the push-message configuration. The methods for managing the reception of messages in accordance with pull and push message configuration will be explained in detail with reference to FIGS. 4 and 5.

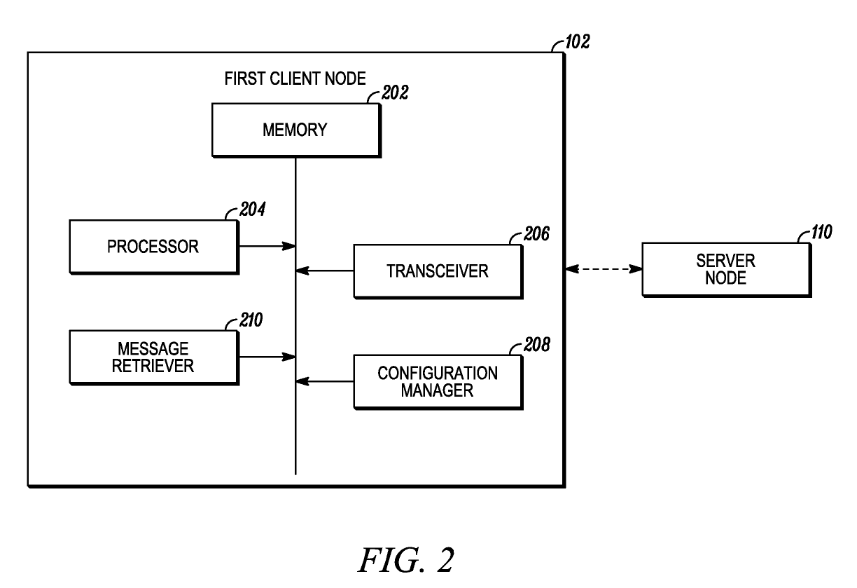

FIG. 2 is a block diagram illustrating various system elements of the first client node 102 of FIG. 1, in accordance with various embodiments of the present invention. The first client node 102 can include a memory 202, a processor 204, a transceiver 206, a configuration manager 208, and a message retriever 210. As mentioned with reference to FIG. 1, the first client node 102 can have one or more email accounts such as the first message account, the second message account, and the third message account. For one embodiment, the first client node 102 can have a pull-message configuration for the first message account, which can be referred to as a pull-message account. Further, the first client node 102 can have a push-message configuration for the second message account, which can be referred as a push-message account.

The memory 202 is configured to store configuration information pertaining to the email accounts associated with the first client node 102. Each of the email accounts is identified based on a message account ID such as rosy98@yahoo.com, dch_{—}79yahoo.co.in, or bill12@gmail.com. The processor 204, coupled to the memory 202, is configured to poll the server node 110 for the first message account, because the first message account has the pull-message configuration. The processor 204 (via the transceiver 206) polls the server node 110 to check for the arrival of a new email message such as a first message that is associated with the first message account.

The transceiver 206, which is coupled to the memory 202, is configured to receive messages from the server node 110. The messages received from the server node 110 can be either user-readable or user-unreadable messages. In one embodiment, for a pull-message account, the transceiver 206 receives a user-unreadable message notifying the first client node 102 of the arrival of a first message, after the client node 102 polls the server node 110 for the pull-message account. Moreover, the transceiver 206 can receive the first message which is a user-readable email message. For a push-message account, the transceiver 206 receives a push-message (user-unreadable message) which notifies the first client node 102 about the arrival of the new message, such as a second message (user-readable email message) associated with the second message account.

For one embodiment, the transceiver 206 receives the push-message from a network device such as a Base Transceiver Station (BTS). The network device can store a list that contains the addresses of the client nodes corresponding to various message account IDs. The server node 110 may not know the address of the first client node 102 associated with the first message account. Therefore, the server node 110 will not be able to deliver the push-message to the first client node 102 directly. In this case, the server node 110 sends the push-message meant for the first message account to a network device. After receiving the push-message from the server node 110, the network device can determine the address of the first client node 102 associated with the first message account. The network device can then deliver the push-message to the transceiver 206 of the first client node 102.

The first client node 102 also includes the message retriever 210 that is configured to retrieve the new email message, such as the first message from the server node 110. The first message is received at the server node 110 when the server node 110 is in pull-message configuration. Further, the message retriever 210 can retrieve the second message after receiving the push-message. The second message is received at the server node 110 when the server node 110 is in push-message configuration. The message retriever 210 can be a Mail Retrieval Agent (MRA) such as fetchmail, retchmail, or getmail. MRA is a computer program that can retrieve email messages from a remote server such as the server node 110.

For one embodiment, the first client node 102 can include only the memory 202 and message software. As mentioned earlier, the message software such as an email client is a front-end computer program that is used to manage the email messages of the email accounts associated with the first client node 102. In this embodiment, the message software can perform the functions of the processor 204, the transceiver 206, the configuration manager 208, and the message retriever 210. Examples of the message software include, but are not limited to, open source Mozilla Thunderbird™, Microsoft Outlook™, a Mail User Agent (MUA), and Mutt™.

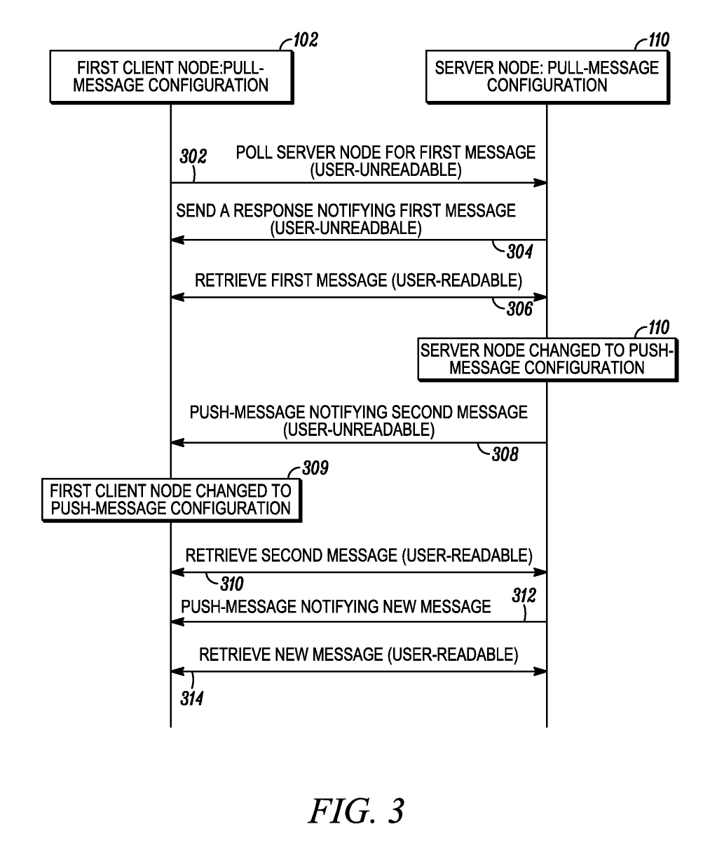

The first client node 102 also includes the configuration manager 208 that is coupled to the memory 202. The configuration manager 208 is configured to change the first client node 102 from a pull-message configuration to a push-message configuration for the first message account under certain circumstances. The configuration of the first client node is changed based on if a push-message is received for the first message account. Thereafter, when the first client node 102 has been changed from a pull-message configuration to a push-message configuration for the first message account, the processor 204 can terminate polling of the server node 110. The method for changing the first client node 102 from the pull-message configuration to the push-message configuration for the first message account will be explained in detail in accordance with FIGS. 3, 4, and 5.

FIG. 3 is a sequence diagram illustrating a method for managing the reception of messages at the first client node 102 in a communication network 100, in accordance with an embodiment of the present invention. The present invention discloses a method that allows the first client node 102 to conveniently switch from a “pull” messaging technology to a more efficient “push” messaging technology for a particular email (or IM) account. Initially, the first client node 102 has a first message account configured as a pull-message account. The server node 110 is also in pull-message configuration. At step 302, the first client node 102 polls the server node 110 to check for an arrival of a new message (such as a first message) associated with the pull-message account. The first client node 102 polls the pull-message account at the server node 110 by sending a user-unreadable message. At step 304, the first client node 102 receives a user-unreadable response message from the server node 110. The user-unreadable response message is a response to the polling message. The user-unreadable response message notifies the first client node 102 about an arrival of a new message (such as a first message) associated with the first message account at the server node 110. At step 306, the first client node 102 retrieves the first message from the server node 110. The first message is a user-readable email message.

Subsequently, the server node 110 changes configuration to a push-message configuration. The server node 110 can change configuration by replacement, upgrading, or another mechanism. At step 308, the reconfigured server node 110 sends a push-message to the first client node 102. The push-message is a notification of arrival of a second message for the first message account at the server node 110. In an embodiment of the present invention, the push-message notification is an Open Mobile Alliance (OMA) Email Notification (EMN). The push-message is just a notification message and it is not readable by a user of the first client node 102. After receiving the push-message, the first client node 102 changes the configuration of the first message account to a push-message configuration. Further, at step 310, the first client node 102 retrieves the second message from the server node 110. The second message is a user-readable email message addressed to the first message account.

After changing the configuration of the first message account from the pull-message configuration to the push-message configuration, the first client node 102 stops polling the server node 110. Now, whenever a new message associated with the push-message account arrives at the server node 110, the server node 110 sends a push-message notifying about a new message to the first client node 102 at step 312. At step 314, the first client node 102 retrieves the new message associated with the push-message account. Subsequently, the first client node 102 having the push-message configuration for the first message account receives a push-message from the server node 110 whenever a new message associated with the first message account arrives at the server node 110.

FIGS. 4 and 5 illustrate a flow diagram detailing a method for managing the reception of messages in the communication network 100, in accordance with another embodiment of the present invention. The method for managing the reception of messages has been explained for the reception of messages for the first message account associated with the first client node 102. As mentioned earlier, the first client node 102 starts with a pull-message configuration for the first message account. The method for managing the reception of messages initiates at step 402. At step 404, the processor 204 polls the server node 110 to check for the arrival of a first message at the server node 110. The first message is associated with the first message account. At step 406, the processor 204 checks whether the first message has arrived at the server node 110. If it is ascertained at step 406, that the first message has not arrived at the server node 110, then the process returns to step 404 for periodic polling after a pre-defined time interval. If it is ascertained at step 406 that the first message has arrived at the server node 110, step 408 is executed.

At step 408, the message retriever 210 retrieves the first message from the server node 110. The message retriever 210 can be a Mail Retrieval Agent (MRA) such as fetchmail, retchmail, or getmail. As mentioned previously, an MRA is usually implemented as a software program that can retrieve email messages from a remote server such as the server node 110. Further, the server node 110 changes from a pull-message configuration to a push-message configuration for the first message account. When the server node 110 is changed to the push-message configuration, it can send a push-message notifying the first client node 102 regarding an arrival of a new second message at the server node 110. The push-message is a user-unreadable message.

At step 410, the processor 204 checks whether a push-message has been received by the transceiver 206. The push-message notifies the first client node 102 about the arrival of a second message at the server node 110. As mentioned previously, the push-message is a notification that is not readable by a user of the first client node 102. The second message is a new message that is associated with the first message account of the first client node 102. For one embodiment, the transceiver 206 receives the push-message directly from the server node 110. For another embodiment, the transceiver 206 receives the push-message via a network device such as a BTS. If the push-message is not received at the first client node 102 at step 410, then the process returns to step 404. If it is verified at step 410 that the push-message has been received at the first client node 102, then step 502 is executed.

At step 502, the configuration manager 208 changes the configuration of the first client node 102 for the first message account from the pull-message configuration to a push-message configuration, based on the push-message. At step 504, the message retriever 210 retrieves the second message from the server node 110. After changing the configuration of the first client node 102, the processor 204 terminates polling of the server node 110 for the first message account at step 506. Thereafter, the method terminates at step 508. Subsequently, the first client node 102 having the push-message configuration for the first message account receives a push-message from the server node 110 whenever a new message associated with the first message account arrives at the server node 110.

For one embodiment, the steps mentioned above can be performed by a message software component such as an email client of the first client node 102. In an embodiment of the present invention, the user of the first client node 102 can manually revert the first message account to a pull-message configuration.

Various embodiments of the present invention offer one or more advantages. The present invention provides a method and system for managing the reception of messages in a communication network. The method and system enables a client node having a pull-message account to receive push emails or push-messages from a server node. For example, a mobile phone having a pull-message account can automatically reconfigure to a push-message configuration and receive push emails from the server node and eliminate unnecessary polling of the server node by a client node. The method and system provides an efficient way to receive messages from the server node. Moreover, the method and system enables a pull-message account of the client node to automatically change its configuration to a push-message configuration on the basis of received push-messages. Subsequently, this client node receives push emails or push-messages from the server node. Once the client node has been configured as a push-message configuration, the client node does not need to poll the server node, and hence, conserves the battery of the client node, because polling of the server node by the client node can deplete the battery life without providing an advantage when no new messages are read. Further, since polling for new messages is no longer required, implementation of the invention also prevents unnecessary communication network traffic that is caused by polling of the server node.

It will be appreciated that the method and system for managing the reception of messages in a communication network, described herein, may comprise one or more conventional processors and unique stored program instructions that control the one or more processors, to implement, in conjunction with certain non-processor circuits, some, most, or all of the functions of the system described herein. The non-processor circuits may include, but are not limited to, signal drivers, clock circuits, power source circuits, and user input devices. As such, these functions may be interpreted as steps of a method and system for managing the reception of messages in a communication network. Alternatively, some or all the functions could be implemented by a state machine that has no stored program instructions, or in one or more application-specific integrated circuits (ASICs), in which each function, or combinations of certain of the functions are implemented as custom logic. Of course, a combination of the two approaches could also be used. Thus, methods and means for these functions have been described herein.

It is expected that one with ordinary skill, notwithstanding possibly significant effort and many design choices motivated by, for example, available time, current technology and economic considerations, when guided by the concepts and principles disclosed herein, will be readily capable of generating such software instructions, programs and ICs with minimal experimentation.

It should be observed that the present invention encompasses combinations of a method and system for managing the reception of messages in a communication network. Accordingly, the method steps have been represented, where appropriate, by conventional symbols in the drawings, showing only those specific details that are pertinent for an understanding of the present invention, so as not to obscure the disclosure with details that will be readily apparent to those with ordinary skill in the art, having the benefit of the description herein.

In this document, the terms “comprises,” “comprising,” or any other variation thereof, are intended to cover a non-exclusive inclusion, such that a process, method, article, or apparatus that “comprises” a list of elements includes not only those elements but may also include other elements that are not expressly listed or inherent in such a process, method, article or apparatus. An element proceeded by “comprises . . . a” does not, without more constraints, preclude the existence of additional identical elements in the process, method, article or apparatus that “comprises” the element. The term “another,” as used in this document, is defined as at least a second or more. The terms “includes” and/or “having”, as used herein, are defined as “comprising”.

In the foregoing specification, the invention and its benefits and advantages have been described with reference to specific embodiments. However, one with ordinary skill in the art would appreciate that various modifications and changes can be made without departing from the scope of the present invention, as set forth in the claims. Accordingly, the specification and figures are to be regarded in an illustrative rather than a restrictive sense, and all such modifications are intended to be included within the scope of the present invention. The benefits, advantages, solutions to problems, and any element(s) that may cause any benefit, advantage or solution to occur or become more pronounced are not to be construed as critical, required or essential features or elements of any or all the claims. The invention is defined solely by the appended claims, including any amendments made during the pendency of this application, and all equivalents of those claims, as issued.

What is claimed is:

1. A method for managing reception of messages in a communication network comprising:
polling a server node, by a first client node having a pull-message configuration for a first message account, to check for an arrival of a first message at the server node associated with the first message account;
receiving a push-message at the first client node, the push-message notifying the first client node of an arrival of a second message at the server node, wherein the second message is a new message associated with the first message account; and
changing the first client node from the pull-message configuration to a push-message configuration for the first message account based on the push-message; and
terminating the polling of the server node for the first message account by the first client node when the first client node is changed from the pull-message configuration to the push-message configuration for the first message account.

2. The method as recited in claim 1 further comprising:
retrieving the second message after the receiving.

3. The method as recited in claim 1, wherein the first message account is an electronic mail account.

4. The method as recited in claim 1, wherein the first message account is an instant messaging account.

5. A first client node in a communication network comprising:
a memory configured to store configuration information for a first message account associated with the first client node and configured as pull-message configuration;
a processor, coupled to the memory, configured to poll a server node to check for an arrival of a first message associated with the first message account;
a transceiver, coupled to the memory, configured to receive a push-message, wherein the push-message notifies the first client node of an arrival of a second message at the server node, the second message is a new message associated with the first message account; and
a configuration manager, coupled to the memory, configured to change the first client node from the pull-message configuration to a push-message configuration for the first message account based on the push-message.

6. The first client node as recited in claim 5 further comprising:
a message retriever, coupled to the processor, configured to retrieve the second message from the server node after receiving the push-message.

7. The first client node as recited in claim 5, wherein the processor is further configured to terminate the polling of the server node for the first message account when the first client node is changed from the pull-message configuration to the push-message configuration for the first message account.

8. The first client node as recited in claim 5, wherein the memory is further configured to store configuration information of one or more message accounts, wherein the one or more message accounts are associated with the first client node.

9. The first client node as recited in claim 5, wherein the first message account is an electronic mail account.

10. The first client node as recited in claim 5, wherein the first message is an electronic mail message.

11. The first client node as recited in claim 5, wherein the first message account is an instant messaging account.

12. The first client node as recited in claim 5, wherein the first message is an instant messaging message.
